(19) United States
(12) Patent Application Publication
(10) Pub. No.: US 2019/0210721 A1
(43) Pub. Date: Jul. 11, 2019

(54) Vector Control for Aerial Vehicle Drive and Method

(71) Applicant: Microdrones GmbH, Siegen (DE)

(72) Inventor: Udo Juerss, Siegen (DE)

(21) Appl. No.: 16/243,709

(22) Filed: Jan. 9, 2019

(30) Foreign Application Priority Data
Jan. 9, 2018 (DE) EP18150763

(51) Int. Cl. B64C 27/58; B64C 27/52; B64C 27/12

(52) U.S. Cl. CPC B64C 27/58; B64C 27/12; B64C 27/52

(57) ABSTRACT

The invention relates to a vector control for an aerial vehicle drive wherein a rotor shaft (16) which is suspended from a frame (19) via a. pivot bearing (18). A rotor (14) is mounted rotatably relative to the rotor shalt (16). A motor (20) is configured to set the rotor (14) in rotation. An actuator (21, 22) which extends between the frame (19) and the rotor shaft (.16) is configured to change the orientation of the rotor shaft (16). The invention also concerns a method for controlling a helicopter drive.

### TECHNICAL FIELD

The present invention relates to an apparatus for affecting vector control of an aerial vehicle drive and a method tor operating an aerial vehicle drive.

### SUMMARY OF THE INVENTION

In an aerial vehicle equipped with such a propulsion system, one or more rotors are set in rotation so that the aerodynamic lift of the rotors overcomes the weight force of the aerial vehicle and the vehicle flics.

In order to be able to control the vehicle in the air, a control device may be provided. One possibility is to van the angle of attack of the rotor blades during a revolution of the rotor in order to generate thrust in a specific direction. This is mechanically complex and leads to a high maintenance cost. In another variant, adjustable air guide blades are arranged in the air flow generated by the rotor. By changing the orientation of such an air guide blade, the air flow can be deflected and hence a thrust generated in a specific direction. This too is mechanically complex. Air guide blades also have the disadvantage that they offer a large attack surface for the wind, whereby the flight stability may be adversely affected.

The invention is based on the object of providing an aerial vehicle drive and a method for operating an aerial vehicle drive so that with simple construction, it is possible to control an aerial vehicle. Starting from the cited prior art, the object is achieved with the features of the independent claims. Advantageous embodiments are given in the subclaims.

The aerial vehicle drive according to the invention comprises a rotor shaft which is suspended from a frame via a pivot bearing. A rotor is mounted rotatably relative to the rotor shaft. A motor is configured to set the rotor in rotation. An actuator extends between the frame and the rotor shaft and is configured to change the orientation of the rotor shaft.

The invention has shown that by pivoting the rotor shaft, it is possible to give the aircraft thrust in a specific direction. Only a pivotable rotor shaft and an actuator acting on the rotor shaft ate required, so that with the aircraft drive according to the invention, a control device can be implemented with few moving parts.

The pivot bearing between the rotor shaft and the frame may have a pivot axis which encloses a right angle with the rotor shaft. The pivot axis may be oriented parallel to a longitudinal direction or parallel to a transverse direction of the aircraft. If the rotor shaft is pivoted about a pivot axis parallel to the longitudinal axis of the aircraft, a rolling movement of the aircraft may be triggered with which the aircraft is tilted about its longitudinal axis. If the rotor shaft is pivoted about a pivot axis parallel to the transverse axis of the aircraft, then a pitching movement of the aircraft may be triggered with which the aircraft is tilted about its transverse axis.

If the aircraft drive is to be able to trigger both a pitching and a rolling movement, the pivot hearing may be pivotable about a first pivot axis and about a second pivot axis, wherein preferably each pivot axis encloses a right angle with the rotor shaft. The first rotor shaft and the second rotor shaft may enclose a right angle between them. The pivot bearing may for example be configured as a cardanic suspension or as a hall joint. Other types of mounting are also possible which allow these movements. With a drive which can trigger both a pitching and a rolling movement, an aircraft can be controlled in any direction.

The actuator may be designed such that it can drive a pivot movement of the rotor shaft about a pivot axis. The pivot axis concerned may for example correspond to a longitudinal axis or a transverse axis of the aircraft. The aircraft drive according to the invention may comprise a first actuator and a second actuator, wherein the actuators are arranged such that they can drive pivot movements of the rotor shaft about different pivot axes. For example, a first actuator may drive a pivot movement about a transverse axis of the aircraft, and a second actuator may drive a pivot movement about a longitudinal axis of the aircraft.

Whereas pivot movements of the rotor shaft relative to the frame are permitted, rotational movements of the rotor shaft about the vertical axis relative to the frame are undesirable. The aircraft drive may therefore comprise a torque bracket between the frame and the rotor shaft which prevents such rotational movements.

The torque bracket may form a structural unit with the pivot bearing. For example, the pivot bearing may comprise a spherical joint part which is guided in a bearing carrier so that the spherical part can rotate in the bearing carrier, while translational movements of the spherical part relative to the bearing carrier are excluded. The torque bracket may comprise a pin, which extends from the spherical part into a recess in the bearing carrier and blocks rotational movements about the rotor shaft. To keep friction low, a thin roller may be arranged on the pin. Other rotational movements between the spherical part and the bearing carrier remain possible. Such a pivot bearing has its own inventive content even without being combined with further features of the aircraft drive.

The motor may be connected to the rotor shaft so that the motor is pivoted together with the rotor shaft. The motor may be arranged coaxially to the rotor shaft so that a direct force transmission is possible between the motor and the rotor. The motor and the rotor may be arranged on the same side of the pivot bearing. The actuator for driving the pivot movement of the rotor shaft may act on the rotor shaft on the opposite side of the pivot bearing viewed from the rotor.

The lever arm between the rotor and the pivot bearing may be shorter than the lever arm between the attack point of the actuator and the pivot bearing. When the rotor rotates, gyroscopic forces occur which have a stabilizing effect on the orientation of the rotor shaft. These gyroscopic forces most be overcome in order to change the orientation of the rotor shaft. The actuator may be tinged and dimensioned such that it can apply sufficient force for this. This may be the case in particular if the rotor is rotating with maximum rotation speed.

The force to be applied by the actuator may be educed by a long lever arm between the attack point on the rotor shaft and the pivot bearing. For example, the lever arm between the attack point of the actuator and the pivot bearing may be 50% longer, preferably 100% longer than the lever arm between the pivot bearing and the rotor.

The invention also concerns an aircraft with such an unmanned aerial vehicle or helicopter type drive, wherein the drive is configured to provide lift to the aircraft. The aircraft may be equipped with a single drive according to the invention. It is also possible that the aircraft is equipped with two or more drives according to the invention. In addition to the helicopter drives according to the invention, the aircraft may comprise one or more in which the orientation of the rotor shaft eat not be changed. All rotors may be configured to give the aircraft lift. As a whole, the aircraft may for example comprise two rotors, four rotors, six rotors, eight more than eight rotors.

In one embodiment the aircraft comprises two rotors which are arranged coaxially to each other in a normal state of the aircraft. Normal state means that the rotor shafts of the two rotors are oriented parallel to a axis of the aircraft. The two rotors may be driven in opposite directions so that the torques are mutually balanced.

If two rotors a arranged coaxially above each other, the efficiency of the lower rotor may be reduced by the air flow from the upper rotor. In this context, it is advantageous if the lower rotor has a vertical distance from the upper rotor. The vertical distance may for example be at least 20%, preferably at least 40%, further preferably at least 50% of the rotor diameter of the upper rotor. In addition or alternatively, the effects of the air flow from the upper rotor may be reduced if one or more air guide plates are arranged between the first rotor and the second rotor. The air guide plates may be rigidly connected to the frame.

The frame of the aircraft may comprise a plurality of installation planes arranged above each other. The installation planes may be oriented parallel to each other. One or more installation planes enclose a right angle with the rotor shaft of an aerial vehicle drive when the aircraft is in normal state.

A first installation plane may carry the bearing carrier of the pivot bearing of a first aerial drive. The rotor and/or the motor of the first aerial vehicle drive may be arranged above the first installation plane. Actuators of the first aerial vehicle drive may be arranged below the first installation plane.

The actuator which extends to the rotor shaft of the first aerial vehicle drive may be attached to a second installation plane. If the first aerial vehicle drive comprises more than one actuator, all actuators may extend from the rotor shaft to the second installation plane. The second installation plane may be arranged below the first installation plane. In particular, the second installation plane may be arranged between two mutually coaxial rotors.

A third installation plane may carry the bearing carrier of the pivot bearing of a second aerial vehicle drive. The third installation plane and the pivot bearing of the aerial vehicle helicopter drive may have the features which have been described in connection with the first installation plate and the first aerial vehicle drive. The third installation plane may be arranged below the first installation plane and/or below the second installation plane.

The actuator or actuators of the second aerial vehicle drive may be attached to a fourth installation plane. The fourth installation plane and the actuators may have the same features which have been described in connection with the second installation plane and the first aerial vehicle drive. The fourth installation plane may be arranged below the first installation plane, below the second installation plane and/or below the third installation plane.

The aerial vehicle may comprise a control unit which is configured to control the motor of the first aerial vehicle drive. Control of the motor may concern the power, so that activation causes an upward or downward movement of the aerial vehicle. The control unit may additionally or alternatively, be configured to control the actuator or actuators of the first aerial vehicle drive. Activation may change the orientation of the rotor shaft so that the rotor acts in a different direction. Activation of the actuators may trigger a movement of the aerial vehicle in a sideways direction.

The control unit may also be configured to activate a second aerial vehicle drive. This may take place in a similar fashion to the first aerial vehicle drive. The actuators of the first aerial vehicle drive and the actuators of the second aerial vehicle drive may be activated such that the rotor shafts tilt in the same direction. In this way, the aerial vehicle may be moved sideways while the vertical orientation of the aerial vehicle remains substantially constant. It is also possible to activate the actuators of the first aerial vehicle drive and the actuators of the second aerial vehicle drive such that the rotor shafts tilt in different directions. In this way, the vertical orientation of the aerial vehicle may be adjusted. The aerial vehicle may be tilted in a sideways direction, combined with a movement in the sideways direction. A tilt in the sideways direction is also possible while the aerial vehicle remains at its location.

The control unit may be configured as a closed control loop. A specific flying state may be predefined to the control loop as a desired value. The aerial vehicle may comprise one or more sensors to detect the actual state of the aerial vehicle. The correcting variables of the control loop may include the power of the motors and the orientation of the rotor shaft.

In normal state of the aerial vehicle in which the rotors are arranged coaxially above each other, the vertical axis of the aerial vehicle may coincide with the rotor shaft. The vertical axis may extend through the center of gravity of the aerial vehicle. For weight distribution, it is favorable if the control unit is arranged close to the vertical axis of the aerial vehicle.

To ensure that the air flow generated by the rotors is disrupted as little as possible, it may be advantageous if the control unit has a shape concentrated about the vertical axis. For example, the control unit may be designed and arranged such that it does not protrude beyond a theoretical cylinder, the axis of which coincides with the vertical axis of the aerial vehicle the diameter of which is smaller than 50%, preferably smaller than 30%, further preferably smaller than 20% of the rotor diameter.

The control unit may be arranged between the first rotor and the second rotor in relation to the vertical dimension. The control unit may be suspended from the second installation plane. It is also possible that an intermediate plane between the first rotor and the second rotor carries the control unit. Alternatively, the control unit may also be arranged above the upper rotor or below the lower rotor.

The motor of the aerial vehicle drive may be an electric motor. Other drive dorms, for example internal combustion engines, are also possible. To supply the electric motors, the aircraft may be equipped with a battery. It is favorable for weight distribution if the battery is arranged close to the vertical axis of the aircraft. Since batteries mostly have a high weight, it may also be advantageous for the weight distribution if the battery is arranged below the lower rotor. However, other positions of the battery, such as between two rotors or above the upper rotor, are also possible.

In order to minimise the disruption of the air flow from the rotors, e battery may have a shape concentrated about the vertical axis of the aircraft. For example, the battery may be designed such that it does not protrude beyond a theoretical cylinder, the axis of which coincides with the vertical axis of the aircraft and the diameter which is smaller than 50% preferably smaller than 30%, further preferably smaller than 20% of the rotor diameter. In addition or alternatively, the motor of the first helicopter drive and/or the second helicopter drive may be designed such that it does not protrude beyond this theoretical cylinder.

The battery arranged below the lower rotor may be carried by the fourth installation plane. Also a further plane carrying the battery may be arranged below the lower rotor. The further plane may, additionally or alternatively, be configured as a transport plane on which a payload carried by the aircraft may be arranged.

The installation planes are preferably configured such that they allow the passage of an air flow generated by the rotors. For example, the installation planes may have openings or consist solely of struts which enclose gaps between them.

The frame of the aircraft may comprise struts to connect installation planes or other planes together in the vertical direction. The connection between the planes may take place via a multiplicity of struts distributed over the periphery of the aircraft. For example, six struts may be distributed evenly about the periphery.

The struts may extend radially outside the rotors. In this way, the struts may also have a protective effect by preventing persons from accidentally coming into contact with the rotating rotor. This may be advantageous in particular in the case of a falling aircraft.

A further means for protecting persons from injury by the aircraft may be a protective cover arranged above the upper rotor. The protective cover may be designed such that firstly it offers protection against accidental contact with the rotor, but secondly it only disrupts the air flow from the rotor to a very slight extent. For example, the protective cover may comprise struts which extend above the upper rotor.

The aircraft may be a manned aircraft or an unmanned aircraft. In the case of a manned aircraft, it may be a small aerial vehicle with an unladen weight of less than 50 kg, preferably less than 20 kg.

The invention also concerns a method for controlling a helicopter drive in which a rotor, which is mounted rotatably relative to the rotor shaft, is set in rotation in order to give lift to an aircraft. The orientation of the rotor shaft relative to a frame of the aircraft is changed in order to control the aircraft.

The method may be refined with further features which are described in connection with the aerial vehicle drive according to the invention or the aircraft according to the invention. The aerial vehicle drive and the aircraft may be refined with further features which are described in connection with the method according to the invention.

The aerial vehicle can be developed with further features that are described in the context of the method according to the invention. The method can be developed with further features that are described in the unmanned aerial vehicle.

The invention is described below as an example with reference to the attached drawings showing advantageous embodiments.

### BRIEF DESCRIPTION OF THE DRAWINGS

The invention is described by way of example below using advantageous embodiments with reference to the enclosed drawings, in which:

FIG. 1, shows a diagrammatic sectional depiction of an aerial vehicle drive according to the present invention;

FIG. 2, shows a section along line A-A in FIG. 1;

FIG. 3, shows a pivot joint of an aerial vehicle drive according to the invention;

FIG. 4, shows a section along line B-B in FIG. 3; and

FIG. 5, shows actuators of an aerial vehicle drive according to the invention.

Although the drawings represent schematic embodiments of the present invention, the drawings are not necessarily to scale and certain features may be exaggerated in order to illustrate and explain the present invention. The exemplification set forth herein illustrates an embodiment of the invention, in one form, and such exemplifications are not to be construed as limiting the scope of the invention in any manner.

### DESCRIPTION OF THE PREFERRED EMBODIMENT

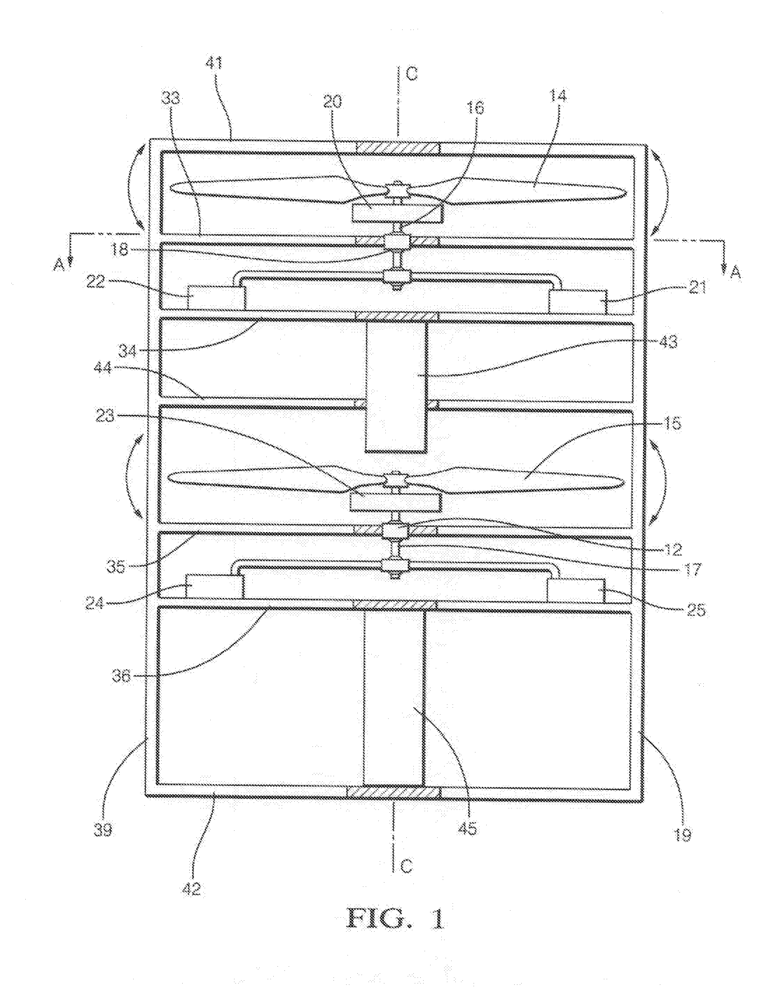

In an unmanned aircraft or aerial vehicle shown in FIG. 1, a first rotor 14 is mounted rotatably on a rotor shaft 16. The rotor shaft 16 is suspended from a frame 19 via a pivot joint 18. Via the pivot joint 18, the orientation of the rotor shaft 16 relative to the frame 19 can be changed. A motor 20 is suspended from the rotor shaft 16 to set the first rotor 14 in rotation. Two actuators 21, 22 act on the lower end of the rotor shaft 16. By activating the actuators 21, 22, the lower end of the rotor shaft 16 may be moved sideways, whereby the orientation the rotor shaft 16 changes. The first rotor 14, the shaft 16, the motor 20 and the actuators 21, 22 together form a first helicopter drive in the sense of the invention.

A second aerial vehicle or helicopter drive according to the invention is arranged below the first aerial vehicle or helicopter drive. The second aerial vehicle drive comprises a second rotor 15, a rotor shaft 17, a pivot bearing 12, a motor 23 and two actuators 24, 25.

FIG. 1 shows the aircraft in the normal state in which the first rotor shaft 16 and the second rotor shaft 17 are oriented coaxially to each other and extend along the vertical axis of the aircraft. When the motors 20, 23 are set in operation in the normal state of the aircraft, so that the rotors 14, 15 rotate opposite directions, the aircraft rises vertically upward from the ground. The torques from the rotors 14, 15 balance each other out, so that the aircraft otherwise retains its position.

FIG. 5 shows the actuators of the first aerial vehicle drive. Each actuator 21, 22 comprises a rotary drive 27 connected to the rotor shaft 16 via a steering rod 28. The steering rods 28 enclose a right angle with each other so that the rotor shaft 16 can be pivoted in any direction by suitable operating of the rotary drives 27.

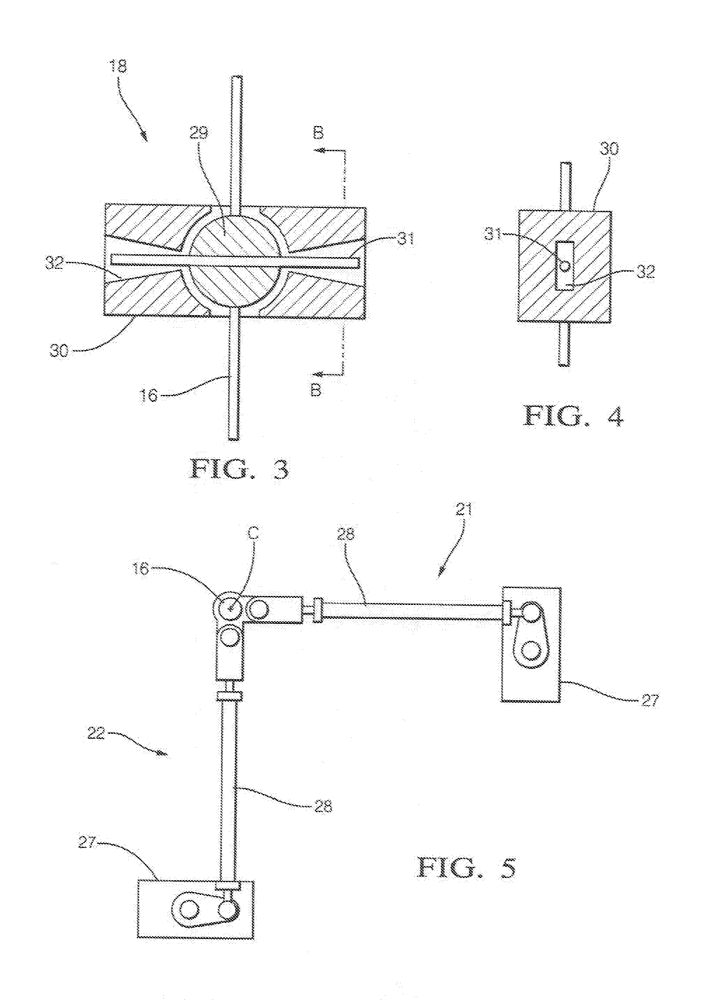

The pivot joint 18 of the aerial vehicle drive according to FIG. 3 is formed as a ball joint in which a spherical joint member 29 is guided in a bearing carrier 30. The rotor shaft 16 is connected to the joint member 29. Two openings 32 are formed in the bearing carrier 30 which widen with an increasing distance from the rotational point of the joint. A pin 31 connected to the joint member 29 is guided into the openings 32. The pin 31 and the openings 32 together form a torque bracket which prevents the rotor shaft 16 from rotating about its own axis relative to the bearing carrier 30. However, pivot movements in any direction are possible as the pin 31 either rotates about its axis or is pivoted inside the openings 32.

The frame 19 of the aircraft comprises a multiplicity of installation planes arranged above each other and connected together via vertical struts. The pivot bearing 18 of the first aerial vehicle drive is suspended from a first installation plane 33. A second installation plane 34 carries the actuators 21, 22 of the first aerial vehicle drive. The pivot bearing 12 of the second aerial vehicle drive is suspended from a third installation plane 35. A fourth installation plane 36 carries 24, 25 of the second aerial vehicle drive.

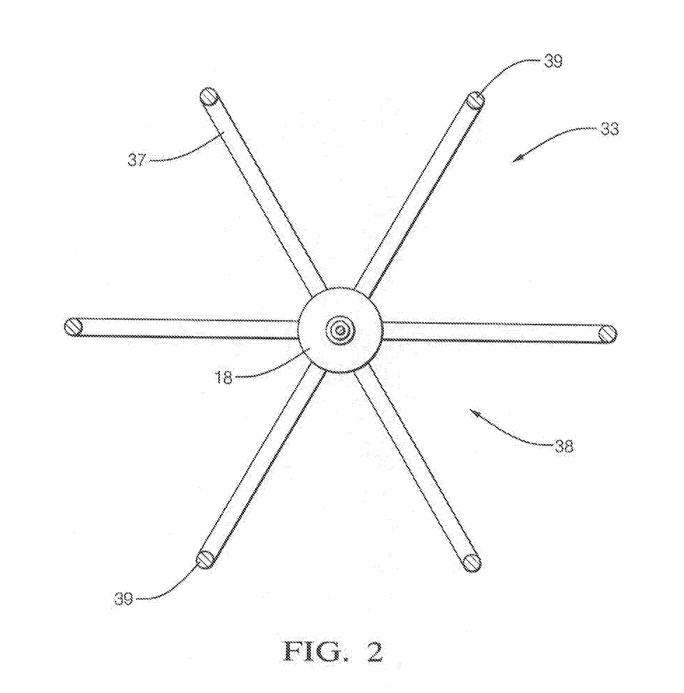

The structure of the installation planes is depicted in FIG. 2 using the example of the first installation plane 33. Six struts 37 extend radially outward from the centrally arranged pivot bearing 18, wherein the radial extension of the struts 37 is slightly larger than the diameter of the rotor 14. Gaps 38 are formed between the struts 37 and are not limited towards the outside. The air flow generated by the rotor 14 can move downward through the gaps 38. The further installation planes 34, 35, 36 are constructed similarly. The struts 37 of all installation planes 33, 34, 35, 36 have corresponding angular orientations so that the gaps 38 lie congruently above each other in a projection along the vertical axis of the aircraft.

The outer ends of the struts 37 are connected together via six vertical struts 39 which extend over the entire height of the aircraft. At the top, the first rotor 14 is covered by a protective cover 41. The protective cover 41 also consists of six struts which are connected together in the middle. A transport plane 42 is suspended from the lower end of the vertical struts 39. The payload to be transported by the aircraft may be transported on the transport plane 42.

A control unit 43 of the aircraft is arranged between the upper aerial vehicle drive and the lower aerial vehicle drive. The control unit 43 is suspended from the first installation plane 34 and from an intermediate plane 44. The control unit 43 extends in a cylindrical form along the vertical axis of the control unit, wherein the radial extension is no greater than the radial extension of the motors 20, 23. In the radially outer region in which the rotors 14, 15 generate the main lift, the air flow is therefore not disrupted by the control unit 43.

A battery 45, which supplies the motors 20, 23 with electrical energy, is arranged below the lower aerial vehicle drive. The battery 45 also ends in a cylindrical form along the vertical axis of the aircraft, wherein the radial extension corresponds to the radial extension the control unit 43.

The motors 20, 23 and the actuators 21, 22, 24, 25 of the two Aerial vehicle drives are activated by the control unit 43. By increasing or reducing the rotation speed of the rotors 14, 14, the aircraft can be moved upward or downward. By activating the actuators 21, 22, 24, 25, the rotor shaft 16, 17 can be tilted in order to adapt the altitude of the aircraft cause a movement of the aircraft in the sideways direction. By changing the rotation speed of the upper rotor and lower rotor relative to each other, a rotation of the aircraft about its vertical axis can be achieved (torque shift) without changing the total lift (no altitude change).

It is to be understood that the invention has been describes with reference to specific embodiments and variations to provide the features and advantages previously described and that the embodiments are susceptible of modification as will be apparent to those skilled in the art. Furthermore, the invention can be employed within UAVs (unmanned aerial vehicles), as well as various forms of manned and unmanned aircraft, including helicopters.

Furthermore, it is contemplated that many alternative, common inexpensive materials can be employed to construct the basis constituent components. Accordingly, the forgoing is not to be construed in a limiting sense.

The invention has been described in an illustrative manner, and it is to be understood that the terminology, which has been used is intended to be in the nature of words of description rather than of limitation.

Obviously, many modifications and variations of the present invention are possible in light of the above teachings. It is, therefore, to be understood that within the scope of the appended claims, wherein reference numerals are merely for illustrative purposes and convenience and are not in any way limiting, the invention, which is defined by the following claims as interpreted according to the principles of patent law, including the Doctrine of Equivalents, may be practiced otherwise than is specifically described.

1. A vector control for an aerial vehicle drive comprising;
a frame:
a rotor shaft suspended from said frame via a pivot bearing;
a rotor mounted for rotation relative to the rotor shaft;
a motor operative to set the rotor in rotation; and
an actuator extending between the frame and the rotor shaft and operable to change the orientation of the rotor shaft.

2. The vector control of claim 1, wherein the pivot bearing is configured as a cardanic suspension or as a ball joint.

3. The vector control of claim 1, wherein the pivot bearing comprises a torque bracket acting between the rotor shaft and the frame.

4. The vector control of claim 1, further comprising a first actuator operative to drive a pivot movement of the rotor shaft about a first pivot axis, and a second actuator operative to drive a pivot movement of the rotor shaft about a second pivot axis.

5. The vector control of claim 1, wherein the motor is connected to the rotor shaft.

6. The vector control of claim 1, wherein the drive is operable to provide lift to the aerial vehicle.

7. The vector control of claim 6, wherein said rotor comprises a first rotor, and further comprising a second rotor oriented coaxially with said first rotor in a normal state of the aerial vehicle drive.

8. The vector control of claim 7, wherein an axial distance between the first rotor and the second rotor corresponds to at least 20%, preferably at least 40%, further preferably at least 50% of the rotor diameter of the upper rotor.

9. The vector control of claim 7, further comprising an installation plane of the frame disposed between the first rotor and the second rotor, and, said actuator of said vector control is attached to said plane.

10. The vector control of claim 8, further comprising a control unit, a battery and/or a motor of the vector control disposed such that they do not protrude beyond a theoretical cylinder, the axis of which coincides with the vertical axis of the aerial vehicle and the diameter of which is smaller than 50%, preferably smaller than 30%, further preferably smaller than 20% of the rotor diameter.

11. The vector control of claim 7, further comprising a multiplicity of installation planes which are connected together via struts, wherein the struts extend radially outside the rotors.

12. The vector control of claim 7, further comprising a protective cover arranged above the upper rotor.

13. A method for controlling a vector control for an aerial vehicle in which a rotor, which is mounted rotatably relative to the rotor shaft, is set in rotation in order to give lift to an aircraft, and in which the orientation of the rotor shaft relative to a frame of the aerial vehicle is changed in order to control the aircraft.

14. A vector control for an aerial vehicle drive comprising:
a frame;
a first rotor shaft suspended from said frame via a first pivot bearing;
a second rotor shall suspended from said frame via a second pivot bearing;
a first rotor mounted for rotation relative to the first rotor shaft;
a second rotor mounted for rotation relative to the second rotor shaft said first rotor mounted coaxially with said second rotor in a normal state of the aerial vehicle drive;
a first motor operative to set the first rotor in rotation;
a second motor operative to set the second rotor in rotation;
a first actuator extending between the frame and the first rotor shaft and operable to change the orientation of the first rotor shaft; and
a second actuator extending between the frame and the first rotor shaft and operable to change the orientation of the first rotor shaft, said first and second actuators circumferentially offset to uni-directionally position the first rotor shaft;
a third actuator extending between the frame and the second rotor shaft and operable to change the orientation of the second rotor shaft; and
a fourth actuator extending between the frame and the second rotor shaft and operable to change the orientation of the second rotor shaft, said third and fourth actuators circumferentially offset to uni-directionally position the second rotor shaft.

15. The vector control of claim 14, wherein the first pivot hearing comprises a torque bracket acting between the first rotor shaft and the frame, and wherein the second pivot bearing comprises a torque bracket acting between the second rotor shaft and the frame.

16. The vector control of claim 14, further comprising:
a first actuator operative to drive a pivot movement of the first rotor shaft about a first pivot axis, and a second actuator operative to drive a pivot movement of the rotor shaft about a second pivot axis; and
p; a second actuator operative to drive a pivot movement of the second rotor shaft about a third pivot axis, and a second actuator operative to drive a pivot movement of the rotor shaft about a fourth pivot axis.

17. The vector control of claim 14, wherein the first motor is connected to the first rotor shaft, and wherein the second motor is connected to the second rotor shaft.

18. The vector control of claim 14, further comprising an installation plane of the frame disposed between the first rotor and the second rotor, and said first and second actuators of said vector control, are attached to said plane.

19. The vector control of claim 18, further comprising a multiplicity of installation planes which are connected together via struts, wherein the struts extend radially outside the rotors.

20. The vector control of claim 14, further comprising a protective cover arranged above the upper rotor.
